(19) United States
(12) Patent Application Publication
(10) Pub. No.: US 2011/0010098 A1
(43) Pub. Date: Jan. 13, 2011

(54) METHOD OF PRE-STACK TWO-DIMENSION-LIKE TRANSFORMATION OF THREE-DIMENSIONAL SEISMIC RECORD

(75) Inventors: Yi Zhan, Hebei (CN); Bo Zhao, Hebei (CN); Xixiang Zhou, Hebei (CN)

Correspondence Address: BANNER & WITCOFF, LTD., 1100 13th STREET, N.W., SUITE 1200, WASHINGTON, DC, 20005-4051, US

(73) Assignees: CHINA NATIONAL PETROLEUM CORPORATION, Beijing (CN); BGP INC., CHINA NATIONAL PETROLEUM CORPORATION, Hebei (CN)

(21) Appl. No.: 12/919,410

(22) PCT Filed: Feb. 24, 2009
(86) PCT No.: PCT/CN2009/000199

§ 371 Date: Aug. 25, 2010

(30) Foreign Application Priority Data
Feb. 25, 2008 (CN) 200810007296.4

(51) Int. Cl. G01V 1/28; G06F 19/00; G01V 1/32

(52) U.S. Cl. 702/17

(57) ABSTRACT

A method of pre-stack two-dimension-like transformation of three-dimensional seismic record is accomplished by the following steps: acquiring 3D seismic data, and arranging them according to a shot gather; calculating the offsets of all the receiver points from the first receiver line of the first shot; making a straight line (L2′) which connects the shot point (S) and the receiver point (R1) of the smallest offset as the transformed coordinate axis, and making the shot point (S) as the center, drawing circles whose radii are the offsets (offseti) of each receiver point, then rotating each receiver point to the straight line (L2′), thereby accomplishing the two-dimension-like transformation of all the receiver lines of the shot, and getting three-dimensional seismic data graph with high precision; and then making the processing of the noise elimination and static correction on the three-dimensional seismic record using conventional technique.

### FIELD OF THE INVENTION

The invention relates to geophysical exploration technologies, more particularly, to a pre-stack processing of three-dimensional seismic data, and to a method of pre-stack two-dimensional-like transformation of three-dimensional seismic record, which directly applies the mature method of pre-stack processing of two-dimensional seismic data to the processing of three-dimensional seismic data.

### DESCRIPTION OF RELATED ART

In geophysical exploration technologies, the seismic data are processed in various ways to increase accuracy of a seismic inversion. Currently, in processing of three-dimensional seismic record, linear characteristic in the two-dimensional record is presented as nonlinear due to special features of the three-dimensional geometry, which leads to the mature method of two-dimensional pre-stack processing can not be directly applied to three-dimensional data during data processing. In order to maintain ‘linearity’ of a linear noise while pre-stack suppressing the linear noise, it is necessary for the three-dimensional record firstly to be extracted as a common offset gather, or to be corrected on velocity, then a processing of noise removal is made using the method of two-dimensional suppressing linear noise, which is not convenient. Furthermore, in static correction of two-dimensional refractive wave, a method of linear fitting primary wave is often employed to obtain an amount of the static correction. However, in a three-dimensional case, except record of the first break presents linear when the shot point is at a certain receiver line, at other receiver lines, record of the first break presents as non-linear. In addition, curvature of the first break changes as the vertical distance between the shot point and the receiver line varies, which increases difficulty for first break fitting and for static correction, whereby inversely affecting efficiency and precision of the static correction processing.

### SUMMARY OF THE INVENTION

The present invention provides a method of two-dimensional-like transformation of three-dimensional pre-stack seismic record, on the basis of which, processing of noise-removal and static correction on the three-dimensional seismic record is made to increase efficiency and accuracy of the processing.

The above object of the present invention is accomplished by the following technical solution:

(1) collecting three-dimensional seismic data in the field by a conventional method, and arranging the three-dimensional seismic data in accordance with a shot gather after said data are decoded;

(2) beginning with the first receiver line of the first shot, calculating offsets (offseti) of all receiver points of the shot according to a coordinate (X, Y) of a shot point (S) and coordinates (Xᵢ, Yᵢ) of all the receiver points,

said offsets are calculated in the following equation:

offsetk=\sqrt{(Xₖ−X)²+(Yₖ−Y)²};

Where k is the offset of the k^{th} receiver point; X, Y are the coordinates of the shot point, and Xₖ, Yₖ are the coordinates of the k^{th} receiver point;

(3) making a straight line (L2′) which connects the shot point (S) and the receiver point (R1) of the smallest offset as the transformed coordinate axis;

(4) making the shot point (S) as a center of a circle, drawing circles with the radii of which are the offsets (offseti) of the respective receiver points, then rotating each receiver point to the straight line (L2′); receiver point (R1′) of said offset is coincident with R, and other receiver points forming a new arrangement as R2′, . . . , Rk′, . . . Rn′, thereby accomplishing the two-dimensional-like transformation of the receiver line;

(5) for another receiver line of the shot, repeating steps (2)-(4) until accomplishing the two-dimensional-like transformation of all the receiver lines of the shot;

(6) for each of the remaining shots, repeating steps (2)-(5) in order, to accomplish the two-dimensional-like transformation of the pre-stack three-dimensional seismic data;

(7) obtaining a three-dimensional seismic data graph with high precision, and making a processing of noise removal and static correction on the three-dimensional seismic record using a conventional method.

The present invention can apply a mature two-dimensional refractor static correction technology to processing of three-dimensional data. According to processing of the present invention, linear characteristic of first break and linear noise is restored well, which assists subsequently processing, suppresses linear noise, and removes noise in a better way.

### BRIEF DESCRIPTION OF THE DRAWINGS

FIG. 1 is a schematic view of a two-dimensional-like transformation of three-dimensional record according to the invention;

FIG. 2 is a schematic view of an actual three-dimensional shot record with three receiver lines which are arranged in a conventional way;

FIG. 3 is a schematic view of the record of FIG. 2 after the two-dimensional-like transformation according to the invention.

### DETAILED DESCRIPTION OF THE PREFERRED EMBODIMENTS

The invention transforms pre-stack three-dimensional record of seismic data to two-dimensional-like record using a method of coordinate transformation and projection.

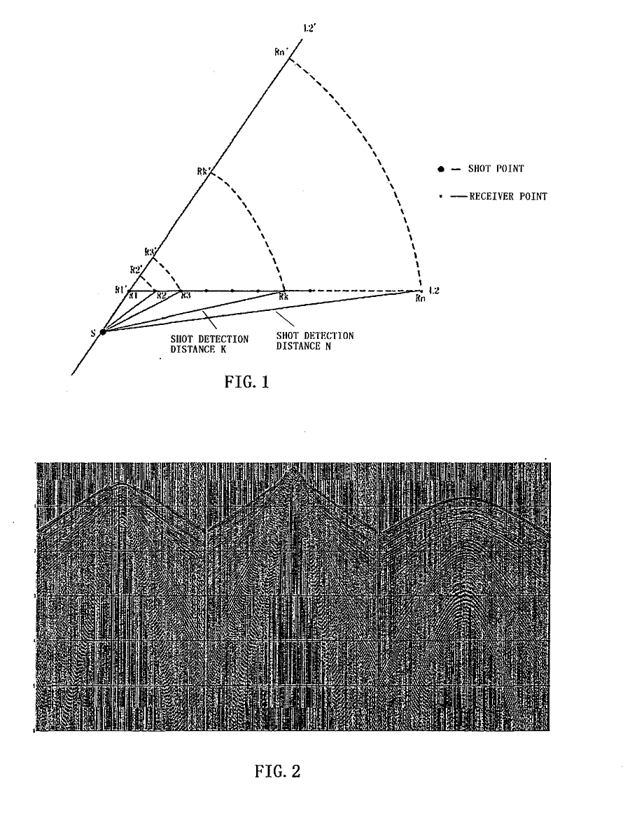

The process of the invention is illustrated in FIG. 1, in which S represents a shot point, R1, R2, . . . , Rn represent receiver points 1˜n, respectively, L2 represents a coordinate of a receiver line composed of these n receiver points, offsetk and offsetn represent actual offsets of the k^{th} and the n^{th} receiver points, respectively; L2′ represents a coordinate of a new arrangement after transformation, and R1′, R2′, . . . , Rk′, Rn′ represent positions of the n receiver points in the new coordinate system after transformation.

The detailed steps are as follows:

(1) collecting three-dimensional seismic data in the field by a conventional method, and arranging the three-dimensional seismic data in accordance with a shot gather after said data are decoded;

(2) beginning with the first receiver line of the first shot, calculating offsets (offseti) of all receiver points of the shot according to a coordinate (X, Y) of a shot point (S) and coordinates (Xᵢ, Yᵢ) of all the receiver points,

said offsets are calculated in the following equation:

offsetk=\sqrt{(Xₖ−X)²+(Yₖ−Y)²};

Where k is the offset of the k^{th} receiver point; X, Y are the coordinates of the shot point, and Xₖ, Yₖ are the coordinates of the k^{th} receiver point;

(3) making a straight line (L2′) which connects the shot point (S) and the receiver point (R1) of the smallest offset as the transformed coordinate axis (as illustrated in FIG. 1);

(4) making the shot point (S) as a center of a circle, drawing circles with the radii of which are the offsets (offseti) of the respective receiver points, then rotating each receiver point to the straight line (L2′); receiver point (R1′) of said offset is coincident with R, and other receiver points forming a new arrangement as R2′, . . . , Rk′, . . . Rn′, thereby accomplishing the two-dimensional-like transformation of the receiver line;

(5) for another receiver line of the shot, repeating steps (2)-(4) until accomplishing the two-dimensional-like transformation of all the receiver lines of the shot;

(6) for each of the remaining shots, repeating steps (2)-(5) in order, to accomplish the two-dimensional-like transformation of the pre-stack three-dimensional seismic data;

(7) obtaining a three-dimensional seismic data graph with high precision, and making a processing of noise removal and static correction on the three-dimensional seismic record using a conventional method.

FIG. 2 is a schematic view of an actual three-dimensional pre-stack record with three receiver lines, which are arranged in a conventional way, in which the longitudinal coordinate is representative of time, and the lateral coordinate is representative of the number of the traces. It can be observed from the drawing that the state of linear noise and first break vary with changes of the vertical distances between the shot points and the receiver lines, more particularly, the smaller the distance, the more the linearity, on the other hand, the larger the distance, the more the non-linearity. In this case, in terms of suppression of linear noise, it is difficult for the mature two-dimensional noise removal method, for example, suppression of linear noise by slope-scan, to obtain good effect on noise removal; and in terms of refractor static correction, since curvature of the first break of the respective receiver line is different, it is difficult to fit the first break and difficult to apply the mature two-dimensional refractor static correction of three-dimensional data.

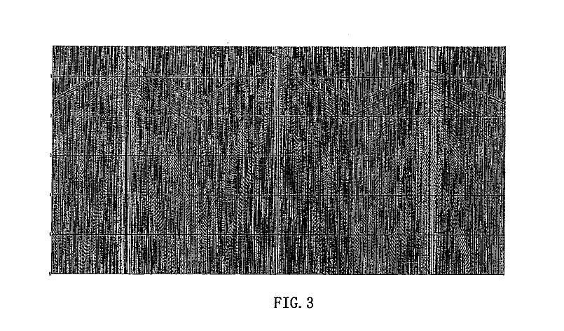

FIG. 3 is a schematic view of the record of FIG. 2 after the two-dimensional-like transformation, in which the abscissa is representative of the offsets, and the longitudinal coordinate is representative of time. It can be seen from comparison between FIG. 2 and FIG. 3 that linear characteristic of the first break and the linear noise in the record is restored after transformation, which assists subsequent processing.

### INDUSTRIAL PRACTICE

The invention relates to geophysical exploration technologies, more particularly, to a pre-stack processing of three-dimensional seismic data. The invention comprises: collecting three-dimensional seismic data and arranging the data in accordance with a shot gather; calculating offsets of all the receiver points from the first receiver line of the first shot; making the shot point as a center of a circle, drawing circles with the radii of which are the offsets of the respective receiver points, then rotating each receiver point to the straight line which cross the shot point and the receiver point with smallest offset to accomplish the two-dimensional-like transformation of all the receiver lines of the shot, obtaining a three-dimensional seismic data graph with high precision, and making processing of noise removal and static correction on the three-dimensional seismic record using a conventional method. According to the invention, linear characteristic of the first break and the linear noise of the three-dimensional pre-stack seismic data is restored so that the two-dimensional mature refractor static correction technology and two-dimensional linear noise attenuation technology can be applied to processing of three-dimensional data, so that the effect of static correction and suppression of linear noise is good, and efficiency and precision of processing are increased, which assists subsequent processing.

The invention can also be applied to other processing of three-dimensional pre-stack seismic data.

What is claimed is:

1. A method of pre-stack two-dimensional-like transformation of three-dimensional seismic record, characterized in that, said method comprising the following steps:
(1) collecting three-dimensional seismic data in the field by a conventional method, and arranging the three-dimensional seismic data in accordance with a shot gather after said data are decoded;
(2) beginning with the first receiver line of the first shot, calculating offsets (offseti) of all the receiver points of the shot according to a coordinate (X, Y) of a shot point (S) and coordinates (Xᵢ, Yᵢ) of all the receiver points;
(3) making s straight line (L2′) which connects the shot point (S) and the receiver point (R1) of the smallest offset as the transformed coordinate axis;
(4) making the shot point (S) as a center of a circle, drawing circles with the radii of which are the offsets (offseti) of the respective receiver points, then rotating each receiver point to the straight line (L2′);
(5) for another receiver line of the shot, repeating steps (2)-(4) until accomplishing the two-dimensional-like transformation of all the receiver lines of the shot;
(6) for each of the remaining shots, repeating steps (2)-(5) to accomplish the two-dimensional-like transformation of the pre-stack three-dimensional record of the seismic data;
(7) obtaining a three-dimensional seismic data graph with high precision, and making processing of noise removal and static correction on the three-dimensional seismic record using a conventional method.

2. The method of pre-stack two-dimensional-like transformation of three-dimensional seismic record according to claim 1, characterized in that, calculating the offset in step (2) as:
offsetk=\sqrt{(Xₖ−X)²+(Yₖ−Y)²};
Wherein k is the offset of the k^{th} receiver point; X, Y are the coordinates of the shot point, and Xₖ, Yₖ are the coordinates of the k^{th} receiver point.

3. The method of pre-stack two-dimensional-like transformation of three-dimensional seismic record according to claim 1, characterized in that, the receiver point (R1′) of said offset is coincident with R, and other receiver points are arranged as R2′, . . . , Rk′, . . . Rn′, thereby accomplishing the two-dimensional-like transformation of the receiver line.
